(19) United States
(12) Patent Application Publication
(10) Pub. No.: US 2017/0193391 A1
(43) Pub. Date: Jul. 6, 2017

(54) ITERATIVE INTERPOLATION OF MAXIMUM ENTROPY MODELS

(71) Applicant: International Business Machines Corporation, Armonk, NY (US)

(72) Inventors: Stanley Chen, New York, NY (US); Bhuvana Ramabhadran, Mount Kisco, NY (US); Ebru Arisoy-Saraclar, New York, NY (US); Abhinav Sethy, Chappaqua, NY (US)

(21) Appl. No.: 14/985,670

(22) Filed: Dec. 31, 2015

(51) Int. Cl. G06N 99/00; G10L 15/197

(52) U.S. Cl. CPC G06N 99/005; G10L 15/197; G10L 2015/0635

(57) ABSTRACT

A plurality of corpora is received from one or more sources. A separate model is trained on each corpus of the plurality of corpora. The models for the plurality of corpora are merged into a joint model using parameter interpolation. The models for each corpus of the plurality of corpora are retrained separately using the joint model. A single model is created based on the retrained models.

### BACKGROUND

NLP deals with the application of computational models to text or speech data. NLP applications may include machine translation, speech recognition, information retrieval, information extraction, etc. Many NLP systems are based on machine learning, for example, using learning algorithms to automatically learn rules through the analysis of large corpora. However, the various corpora used in training NLP systems may come from disparate sources.

### SUMMARY

Embodiments of the invention provide techniques for generating models for use in NLP using iterative interpolation.

For example, in one embodiment, a method comprises the following steps. A plurality of corpora is received from one or more sources. A separate model is trained on each corpus of the plurality of corpora. The models for the plurality of corpora are merged into a joint model using parameter interpolation. The models for each corpus of the plurality of corpora are retrained separately using the joint model. A single model is created based on the retrained models.

In another embodiment, an apparatus comprises a memory and a processor operatively coupled to the memory and configured to implement one or more of the above mentioned steps.

In yet another embodiment, a computer program product comprises a computer readable storage medium for storing computer readable program code which, when executed, causes a computer to perform one or more of the above mentioned steps.

### BRIEF DESCRIPTION OF THE DRAWINGS

FIG. 1 illustrates an overview process of a methodology for generating one or more language models using iterative interpolation, according to an embodiment of the invention.

FIG. 2 illustrates a flow chart of the iterative interpolation process used in the methodology of FIG. 1.

FIG. 3 illustrates an exemplary embodiment of a system for implementing the methodology of FIG. 1.

FIG. 4 illustrates a cloud computing environment, according to an embodiment of the invention.

FIG. 5 depicts abstraction model layers according to an embodiment of the invention.

### DETAILED DESCRIPTION

Embodiments of the invention relate to natural language processing (NLP), and more specifically, to generating models for use in NLP using iterative interpolation.

Illustrative embodiments of the invention may be described herein in the context of illustrative methods, systems and devices for generating models using iterative interpolation. However, it is to be understood that embodiments of the invention are not limited to the illustrative methods, systems and devices but instead are more broadly applicable to other suitable methods, systems and devices. For example, while various embodiments herein relate to Automatic Speech Recognition (ASR) systems, it is to be understood that embodiments herein may be applicable to other NLP systems, such as machine translation and text classification.

NLP may be useful for various applications, including ASR systems. In ASR systems that include language model components, given a sequence of spoken words, the job of a language model is to assign a probability to each word or word sequence based on its likelihood of occurrence in the specific context based on the acoustic information. This probability is generated from a statistical model, whose parameters are estimated on data. However, this data may come from numerous disparate sources. Moreover, some data might be large in size, but not useful, while some data might be well matched to the domain (e.g., data for a voice command application) and useful but small in size, which may result in the small data being overwhelmed by the large data.

Moreover, ASR systems that use interpolation algorithms based on score combination, such as linear and log linear interpolation, work on models trained separately for each corpus. Thus, they do not include the benefit of joint training across all corpora. Also, multiple models have to be deployed at runtime, which adds computational time and memory burden. On the other hand, techniques such as Minimum Discriminant Information (MDI) and EasyAdapt can be used to build a joint model across corpora but these techniques are hard to tune. Tuning typically requires multiple training cycles with a grid search involving varying regularization penalties and other hyper-parameters across corpora, which can be computationally expensive and is an impractical solution for large corpora. A simpler approach is to weight the n-gram counts from the corpora, but the interaction between corpus importance, corpus size and prior weights is not clear for count weighting.

One type of models used in ASR systems is Maximum Entropy (MaxEnt) models (e.g., exponential n-gram models). MaxEnt models are useful for various natural language processing applications, such as machine translation, text classification, sentiment detection and speech recognition. For many tasks, corpora for training MaxEnt models are available from a collection of diverse data sources.

In practice, building models separately and interpolating tends to give better performance. A good scheme for using multiple corpora together is specifically important for MaxEnt language models, such as ModelM, where large amounts of data from different corpora are available and optimally combining the various sources while creating one model is key to getting good improvements in word error rate (WER).

Advantageously, embodiments of the invention provide methods and systems to train a single model on all the data together. Various embodiments herein train a single model on all the data together, as larger corpora tend to give more robust estimates of the parameters. Also, a single model is desirable from deployment runtime cost point of view. Various embodiments herein use Alternative Direction Method of Multipliers (ADMM) to train exponential n-gram models jointly while weighting the different corpora to optimize performance on a new domain. Embodiments of the invention work with multiple corpora efficiently in contrast to MDI, which works best when there is a clear out-of-domain corpus and an in-domain corpus. Additionally, the interpolation weights are found during the training process itself and no costly tuning is required. Furthermore, various embodiments herein cycle between the following steps in an ADMM framework to:
1) Build models separately for each corpus;
2) Use log linear interpolation to get the single model best fitted to the data;
3) Use the interpolated model as a Gaussian prior and retrain models for each corpus; and
4) Repeat interpolation and training until convergence of held-out perplexity (PPL) to generate a single best fit model, for example, a best fit language model.

The iterative process can be linked to weighted training by looking at ADMM. Therefore, various embodiments herein provide an interpolation scheme that would:
A. Lead to a single model at deployment for low runtime computation and memory cost.
B. Provide joint training of model(s) for leveraging similarities across corpora: retraining with a shared prior retains the benefits of joint training.
C. Provide easy tuning of weights/domain parameters for fast training on large corpora: weights can be tuned easily on a held-out set without any grid search on training hyper parameters.
   The methods and systems described herein are applicable to any application where MaxEnt models are used. For example, but not limited to, text classification, machine translation, information retrieval, etc.

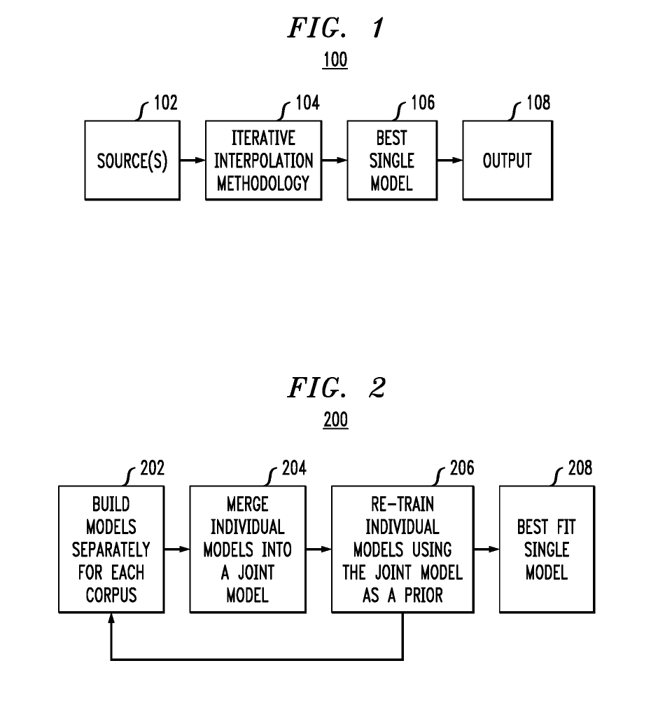

Referring to the figures, FIG. 1 depicts an overview of a methodology 100 for performing iterative parameter interpolation with ADMM for ASR systems, according to an embodiment. At step 102, data from one or more sources (e.g., database, journals, websites, etc.) are obtained. The data may be text data used as training data for building one or more language models to be used in ASR systems. Then at step 104, iterative parameter interpolation with ADMM is performed on the data. Details of step 104 will be delineated in the context of FIG. 2 below. Then at step 106, a single best fit model is determined. At step 108, the single model is sent as output for used in an NLP application, such as a speech decoding process of an ASR system, which may be implemented as part of a computing device. The computing devices used herein may be, for example, but not limited to, a portable computing device, a mobile phone, a tablet, a computer, a vehicle having an ASR system, etc.

FIG. 2 shows a flow chart of an illustrative process for performing iterative parameter interpolation (e.g., log linear interpolation) with ADMM on obtained data, according to an embodiment of the invention. Process 200 delineates step 104 of FIG. 1 above. Process 200 starts at step 202, in which a separate model is built for each corpus of obtained data. As used herein, a corpus may refer to a collection of writings or recordings (e.g., a set of documents or sentences) used for linguistic analysis. For example, if data is obtained from a website, an article, and a database, one model will be built separately for each of these sources. At step 204, the individual models from step 202 are merged together to form a joint model, for example, a joint language model. The merging step may be performed using parameter interpolation (e.g., log linear interpolation) with weights optimized on a held-out set for a given performance metric. The performance metric may be, for example, log likelihood or classification accuracy. Then at step 206, the individual models are re-trained using the joint model as a prior and the process goes back to step 202. This process is repeated until convergence of held-out PPL. Convergence may be determined based on a comparison of the performance measured in terms of log likelihood on the held-out set, or other suitable metric, between the current joint model and the previous joint model. If the performance of the current model is worse than the previous model, the iterative training may be stopped. Also, if no improvement or minimal improvement is detected in the current joint model as compared to the previous joint model, then the current joint model is considered to be the best fit single model 208 based on the obtained data. This best fit single model 208 may then be sent as output, for example, to an ASR system for use in speech decoding. Details relating to the steps described above are delineated below.

Alternating Direction Method of Multipliers (ADMM)

ADMM is a framework for distributed optimization of sum of convex functions with linear constraints on parameters:

Minimize f(x)+g(z)

Subject to Ax+Bz=c

As such, various embodiments herein may apply to any convex model, and one constraint is that the model has to be essentially based on convex optimization. If that condition is satisfied, the MaxEnt model is satisfied. Furthermore, various embodiments of the invention described herein focus on MaxEnt models. In embodiments described herein, instead of averaging gradients in each iteration we average the parameter vectors in each meta-iteration. ADMM aims for reducing communication cost even if overall number of iterations is larger. We consider the specific case of ADMM where the functions we want to sum share the same parameter vector.

In this case, ADMM optimizes the problem:

Minimize Σᵢ₌₁^{N}fᵢ(xᵢ)

Subject to xᵢ−z=0

The ADMM solution to the problem can be written as:

$$\begin{matrix}{x}_{i}^{k + 1} = {argmin}_{x} ( {f}_{i} ( {x}_{i} ) + {y}_{i}^{kT} ( {x}_{i} - {\overline{x}}^{k} ) + ( ρ \text{/} 2 ) {‖ ( {x}_{i} - {\overline{x}}^{k} ) ‖}_{2}^{2} ) & Equation ( 1 ) \\ {y}_{i}^{k + 1} = {y}_{i}^{k} + ρ ( {x}_{i}^{k + 1} - {\overline{x}}^{k + 1} ) & Equation ( 2 ) \\ {z}^{k + 1} = {\overline{x}}^{k + 1} = {\sum }_{i = 1}^{N} {x}_{i}^{k + 1} & Equation ( 3 )\end{matrix}$$

In equations (1), (2) and (3) above, x represents the parameters of the model; ƒ represents the function to be minimized, e.g., the model, you want to find a model that minimizes the value of ƒ on the training data; x̅^{k} represents the consensus, such that any parameter that is too far from the consensus is penalized; y represents the penalty term, which measures how far away a model is from the values of the joint model; k represents the current iteration, such that zero means there is no joint model yet and the models are being trained independently, and for k≧1, there is a joint model, where the individual models from the previous iteration are taken and merged together to form the joint model; and z represents the merged or joint model, which is determined by taking the sum of all the models at iteration k. Model parameters for an exponential n-gram model may be a set of weights attached to a set of features that reflect how important the features are to the model. For example, the feature “President Barack=>Obama” which is active if the next word is “Obama” and last two words are “president” and “Barack” should receive a high weight in a language model which predicts the next word given the last few words.

In each iteration, the following is performed:
1) Gather xᵢ^{k} and take the average to get x̅^{k+1}.
2) Scatter the average x̅^{k+1}.
3) Update yᵢ^{k} locally in parallel.
4) Solve for xᵢ locally with modified ADMM objective function (i.e., equation (1) above).
   The averaging step builds a consensus model which is then transmitted to distributed nodes that may use it as a prior for re-training the models. Each iteration can be viewed as a maximum a posteriori (MAP) estimation with Gaussian prior:

$${\overline{x}}^{k} + \frac{1}{ρ} {y}_{i}^{k} \qquad Equation ( 4 )$$

This Gaussian prior can be interpreted as the average model plus a penalty term, which tracks how much the current model differs from the average.

Training with Weighted Objective Functions

Now we go back to training a weighted sum of ModelM objective functions (i.e., the individual models for each corpus):

$${\sum }_{c = 1}^{C} {w}_{c} {f}_{c} ( x ) \qquad Equation ( 5 )$$

For a weighted objective function:

$$\begin{matrix}{\sum }_{c = 1}^{C} {w}_{c} {f}_{c} ( x ) & {w}_{c} \geq 0 & {\sum }_{c} {w}_{c} = 1\end{matrix} \qquad Equation ( 6 )$$

The ADMM averaging step is:

$$\overline{x} = {\sum }_{i = 1}^{N} {w}_{i} {x}_{i} \qquad Equation ( 7 )$$

Notably, when log linear interpolation is used, choosing objective function weights is equivalent to finding log linear weights. Furthermore, x̅ in equation (7) above represents the merged or joint model, which is calculated from the weighted sum of the parameters across all corpora. The weights are determined per corpus, so if there are ten corpora, we have to find ten different weights, which may be done using interpolation methods, such as log linear interpolation. For example, if there are four parameters, x₁ . . . x₄, then there are four weights W₁ . . . W₄ respectively, and x̅=W₁x₁+W₂x₂+W₃x₃+W₄x₄. As such, there is a new interpolated model each time the separate models are merged. At the end of the iterative process when convergence is reached, that joint model x̅ is the best fit single model to be used in an NLP application, such as a speech decoder or speech decoding. While the example above includes only four parameters, it is to be appreciated that more or less parameters may be included.

Finding Log Linear Weights

Consider the λ values from each model for each output symbol as feature φₕ(c, y). We train a conditional exponential model optimizing the likelihood of the held-out set with parameters W_{c} representing one weight for each corpus. The feature weights, W_{c}, learnt are the optimal log linear interpolation weights. For ADMM iterative training, the weights should be positive and sum-to-one. We use the exponentiated gradient descent algorithm to optimize the weights.

Iterative Log Linear Interpolation with ADMM

As an example, a system implementing an embodiment of the invention may obtain data for training from a plurality of sources. The system may then build models separately for each corpus of the various sources. Subsequently, log linear interpolation may be used to get the best fit single model for the data. Then, the interpolated model may be used as a Gaussian prior to retrain the model for each corpus. The interpolation and re-training may be repeated until convergence of held-out PPL. This best fit single model may then be used in an ASR system for speech decoding applications. Notably, the best fit single model may be re-determined each time one or more new data sources are obtained or if the data is updated.

Illustratively, consider a speech recognition system that is meant to transcribe medical lectures. While there is a lot of content available from sources, such as Wikipedia® and WebMD®, the amount of text corresponding to medical lectures is probably much smaller. In order to build a language model for this domain, we may have a great deal of individual sources which vary in the amount of material and fit to the problem of interest. We can use various embodiments described herein, with a set of medical lectures as a held-out set, and build a single model which jointly trains on all these corpora with the right weighting. The single model can then be used in the medical lectures domain.

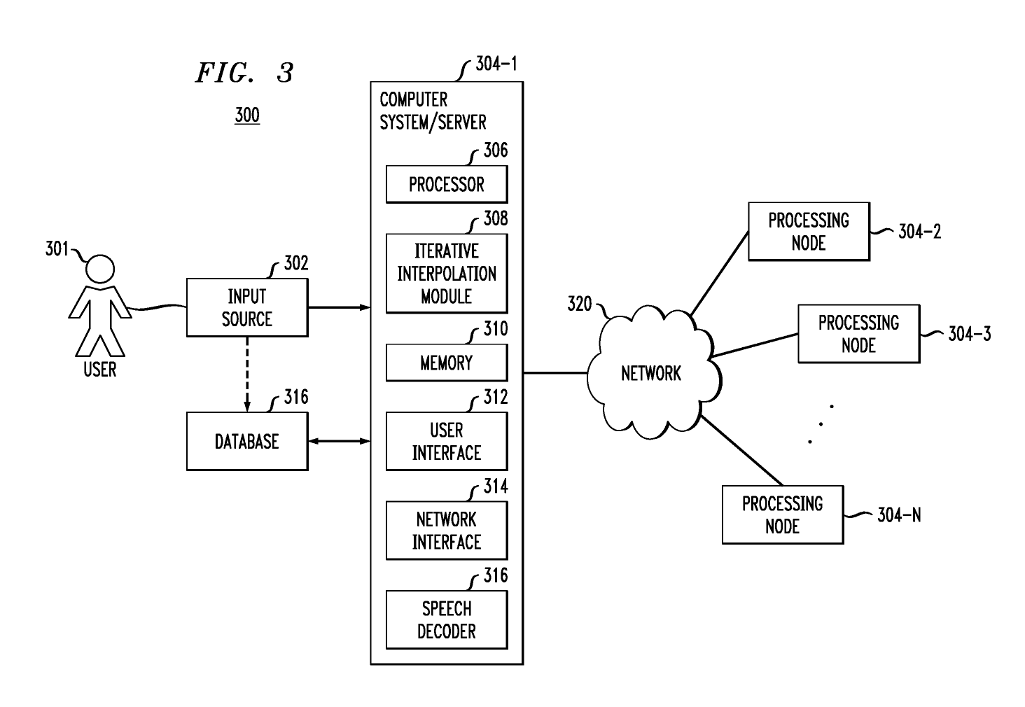

FIG. 3 depicts a system 300 for implementing methodology 100 of FIG. 1. System 300 processing nodes 304-1 . . . 304-N, configured to communicate over a network 320. Each of processing nodes 304-1 . . . 304-N may be configured as shown in computer system/server 304-1, which may include, but is not limited to, wearable devices, personal computer systems, server computer systems, thin clients, thick clients, hand-held or laptop devices, multiprocessor systems, microprocessor-based systems, programmable consumer electronics, network PCs, minicomputer systems, mainframe computer systems, and distributed cloud computing environments that include any of the above systems or devices, and the like. Computer system/server 304-1 may include one or more processors 306 coupled to a memory 310, a user interface 312 and a network interface 314. Computer system/server 304-1 may comprise an iterative interpolation module 308 for implementing one or more steps of methodology 100 of FIG. 1. The iterative interpolation module 308 may be part of an ASR decoder (not explicitly shown), which may use a language model generated by iterative interpolation module 308 to recognize speech input to the computer server/system 304-1 so as to generate a decoded speech output. User interface 312 may be configured to enable user input into the computer system/server 304-1. Network interface 314 may be configured to enable the computer system/server 304-1 to interface with a network and other system components.

The computer system/server 304-1 may be configured to obtain and/or receive input 302 from sources such as one or more users 301, one or more other sources (e.g., websites, journals, etc.) and/or one or more databases 316. Database 316 may store one or more data sets, such as training text, previously stored language models, and/or store results from the iterative interpolation module 308. Data may periodically be transmitted between user 301, database 316 and the one or more processing nodes 304-1 . . . 304-N via network 320. Network 320 may be a communication link comprising an internet connection, Ethernet link, local area link, cellular link, satellite link, global system for mobile communication (GSM), etc. It is to be appreciated that system 300 may include more or less components than shown in FIG. 3. For example, system 300 may include multiple ones of database 316, input 302 and may also include additional components suitable for implementing methodology 100 of FIG. 1.

Embodiments of the invention may be a system, a method, and/or a computer program product at any possible technical detail level of integration. The computer program product may include a computer readable storage medium (or media) having computer readable program instructions thereon for causing a processor to carry out aspects of the invention. For example, computer system/server 304-1 may comprise a computer program product for implementing embodiments of the invention disclosed herein.

The computer readable storage medium (e.g., memory 310) can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network (e.g., network 320), including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing below, implementation of the teachings recited herein are not limited to a cloud computing environment. Rather, embodiments of the invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

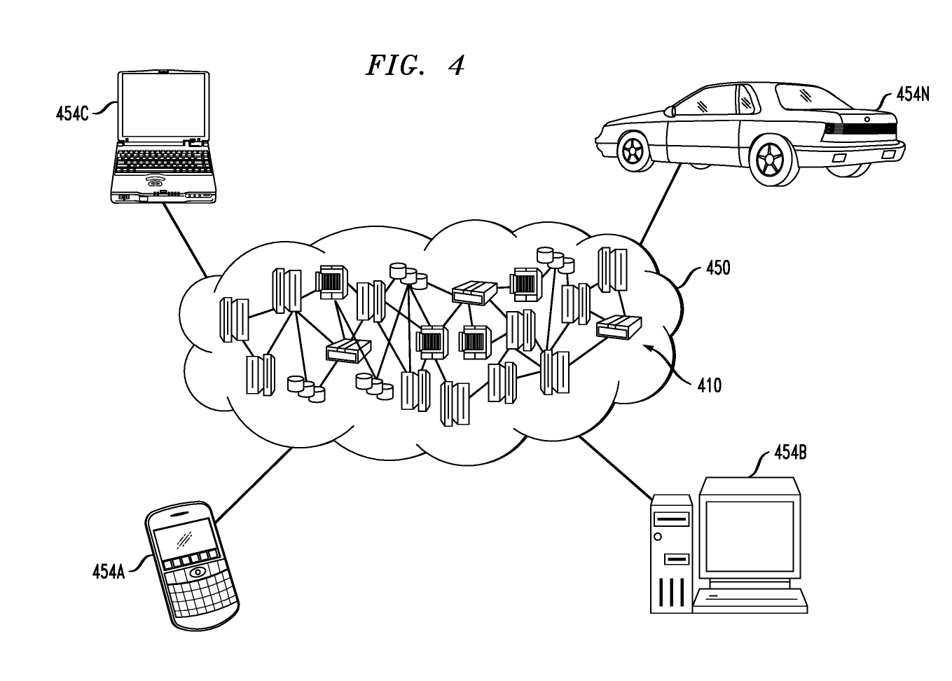

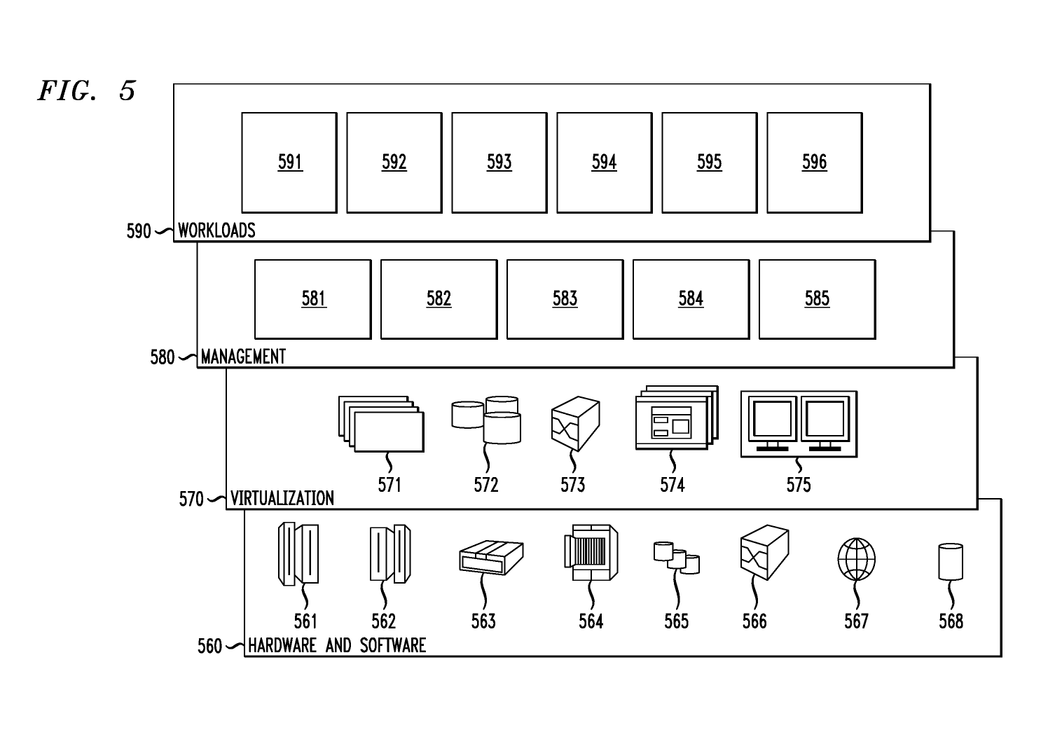

Referring now to FIG. 4, illustrative cloud computing environment 450 is depicted. As shown, cloud computing environment 450 comprises one or more cloud computing nodes 410 with which local computing devices used by cloud consumers, such as, for example, a wearable device (not explicitly shown), a personal digital assistant (PDA) or cellular telephone 454A, desktop computer 454B, laptop computer 454C, and/or automobile computer system 454N may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 450 to offer infrastructure, platforms and/or software as services for which a cloud consumer does not need to maintain resources on a local computing device. It is understood that the types of computing devices 454A-N shown in FIG. 5 are intended to be illustrative only and that computing nodes 410 and cloud computing environment 450 can communicate with any type of computerized device over any type of network and/or network addressable connection (e.g., using a web browser).

Referring now to FIG. 5, a set of functional abstraction layers provided by cloud computing environment 450 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provide pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; virtual classroom education delivery 593; data analytics processing 594; transaction processing 595; and generating models using iterative interpolation 596, which may implement one or more functions described above.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising the steps of:
receiving a plurality of corpora from one or more sources;
training a separate model on each corpus of the plurality of corpora;
merging the models for the plurality of corpora into a joint model using parameter interpolation;
retraining the models separately for each corpus of the plurality of corpora using the joint model; and
creating a single model based on the retrained models;
wherein the steps are performed by at least one processor device coupled to a memory.

2. The method of claim 1, wherein the single model is a language model for use in a speech decoding process.

3. The method of claim 1, wherein training a separate model on each corpus comprises training exponential n-gram models.

4. The method of claim 1, wherein the training step comprises applying an Alternative Direction Method of Multipliers framework.

5. The method of claim 1, further comprising determining a log linear weight for each corpus of the plurality of corpora.

6. The method of claim 5, wherein merging the models comprises taking a weighted sum of a plurality of parameters across the plurality of corpora.

7. The method of claim 6, further comprising interpolating the plurality of parameters to create the joint model.

8. The method of claim 1, wherein retraining the models comprises using the joint model as a Gaussian prior.

9. The method of claim 1, wherein creating the single model comprises repeating the training, merging and retraining steps.

10. The method of claim 9, wherein the steps are repeated until convergence of a held-out perplexity.

11. An apparatus comprising:
a memory and a processor operatively coupled to the memory and configured to implement the steps of:
receiving a plurality of corpora from one or more sources;
training a separate model on each corpus of the plurality of corpora;
merging the models for the plurality of corpora into a joint model using parameter interpolation;
retraining the models separately for each corpus of the plurality of corpora using the joint model; and
creating a single model based on the retrained models.

12. The method of claim 11, wherein the single model is a language model for use in a speech decoding process.

13. The method of claim 11, wherein the training a separate model on each corpus comprises training exponential n-gram models.

14. The method of claim 11, wherein the training step comprises applying an Alternative Direction Method of Multipliers framework.

15. The method of claim 11, further comprising determining a log linear weight for each corpus of the plurality of corpora.

16. The method of claim 15, wherein merging the models comprises taking a weighted sum of a plurality of parameters across the plurality of corpora.

17. The method of claim 16, further comprising interpolating the plurality of parameters to create the joint model.

18. The method of claim 11, wherein retraining the models comprises using the joint model as a Gaussian prior.

19. The method of claim 11, wherein creating the single model comprises repeating the training, merging and retraining steps.

20. A computer program product comprising a computer readable storage medium for storing computer readable program code which, when executed, causes a computer to:
receive a plurality of corpora from one or more sources;
train a separate model on each corpus of the plurality of corpora;
merge the models for the plurality of corpora into a joint model using parameter interpolation;
retrain the models separately for each corpus of the plurality of corpora using the joint model; and
create a single model based on the retrained models.
